(19) United States
(12) Patent Application Publication
(10) Pub. No.: US 2013/0200234 A1
(43) Pub. Date: Aug. 8, 2013

(54) MOUNTING CLAMP AND MOUNTING CLAMP CONFIGURATION FOR PHOTOVOLTAIC MODULE INSTALLATION

(71) Applicant: First Solar, Inc., Perrysburg, OH (US)

(72) Inventors: Zhibo Zhao, Novi, MI (US); Benyamin Buller, Sylvania, OH (US); David Hwang, Perrysburg, OH (US); Dmitriy Marinskiy, Tampa, FL (US); Muhammad Khatri, Perrysburg, OH (US); Zhengjue Zhang, Perrysburg, OH (US); Allan Ward, III, Perrysburg, OH (US)

(73) Assignee: First Solar, Inc., Perrysburg, OH (US)

(21) Appl. No.: 13/759,846

(22) Filed: Feb. 5, 2013

Related U.S. Application Data
(60) Provisional application No. 61/595,370, filed on Feb. 6, 2012.

(51) Int. Cl. H01L 31/042; B23P 19/00

(52) U.S. Cl. CPC H01L 31/0422; B23P 19/00
USPC 248/226.11; 29/428

(57) ABSTRACT

Disclosed are photovoltaic module mounting assemblies with mounting clamps for connecting multiple photovoltaic modules into a photovoltaic array. One embodiment of the mounting assembly includes mounting clamps that are positioned on the mounting assembly parallel to the scribe lines of the module. Another embodiment of the mounting assembly uses mounting clamps that are configured to hold a portion of the module at a predetermined distance away from the photovoltaic cells of the module.

This application claims priority to provisional application No. 61/595,370, filed on Feb. 6, 2012, which is incorporated herein by reference.

### FIELD OF THE INVENTION

Disclosed embodiments relate to the field of photovoltaic (PV) power generation systems, and more particularly to photovoltaic module installation using mounting clamps.

### BACKGROUND OF THE INVENTION

A photovoltaic module or solar module, also known as a solar panel, is a device that converts the energy of sunlight directly into electricity by the photovoltaic effect. Referring to FIGS. 1A and 1B, a photovoltaic module 100 includes a plurality of photovoltaic cells 10, also known as solar cells, for example, crystalline silicon cells or thin-film cells. In thin-film photovoltaic modules, the photovoltaic cell 10 can include various materials formed between a front support 11 and a back support 15. The various materials can include, for example, a first conductive material 12, e.g., a transparent conducting oxide (TCO) material, an active material 13 and a second conductive material 14, e.g., a back contact material. The front 11 and back 15 supports are made of a transparent material, such as, glass, so that the front support 11 allows light to pass through to the active material 13. The active material 13 is formed of semiconductor materials, for example, a cadmium sulfide (CdS) window layer and a cadmium telluride (CdTe) absorber layer adjacent the cadmium sulfide (CdS) window layer, although other semiconductor materials can be used. The first 12 and second 14 conductive materials act as electrodes. An electrical insulator 16 edge seal encapsulates and seals the peripheral edge 20 of the module 100 to create a suitable tracking distance from the active material 13 to the exterior of module 100 for reducing the risk of electrical shock.

In the exemplary thin-film cell 10 shown in FIG. 1B, portions of the material layers are removed to form electrical connections to the first conductive material 12 and the second conductive material 14 and define individual photovoltaic cells. The cells may be connected in series, in parallel or in a combination thereof. This is typically accomplished via a scribing process that uses pulsed lasers to form laser scribes 17a, 17b and 17c. Multiple photovoltaic cells 10 are formed and electrically connected by the laser scribes 17a-c to form a photovoltaic module 100. The exemplary photovoltaic module 100 has a longer length (L) than width (W). For example, module 100 may have a length (L) of four (4) feet and a width (W) of two (2) feet, although any module size can be fabricated using the methods discussed herein. In the conventional photovoltaic module 100, the laser scribes 17a-c are formed perpendicular to the longer length (L) of the module 100 as shown in FIG. 1 A. An edge delete area 20 of a photovoltaic module 100 is typically formed at the edge which defines a perimeter around the photovoltaic cell 10 areas and which does not participate in the conversion of solar photons to electrical power.

Referring to FIG. 2, photovoltaic modules fabricated using the methods discussed herein may be incorporated into one or more photovoltaic arrays 1000 that are mounted on a photovoltaic module mounting assembly 200. The arrays 200 may be incorporated into various systems for generating electricity. Electricity is produced as photons in sunlight pass through the front support 11 and are absorbed by the active material 13 (FIG. 1B). When a photon is absorbed, its energy generates electron-hole pairs that create an electric field at the p-n junction of the photovoltaic cell 10 formed by the window and absorber layers. The p-n junction acts as a diode permitting photocurrent to flow in one direction. The photocurrent may be collected and converted from direct current (DC) to alternating current (AC) and distributed to a power grid. Light of any suitable wavelength may be directed at the module to produce the photocurrent, including, for example, light of wavelengths between 400 nm and 700 nm. Photocurrent generated from one photovoltaic module 100 may be combined with photocurrent generated from other photovoltaic modules 100. For example, the photovoltaic modules 100 may be part of a large photovoltaic array 200, from which the aggregate current may be harnessed and distributed.

As shown in FIG. 2, one example of the mounting assembly 200 can include a plurality of supporting beams 210 and a plurality of supporting rails 220. The supporting beams 210 are substantially parallel to each other. The supporting rails 220 are substantially parallel to each other and are fastened substantially perpendicular to the supporting beams 210 using connectors 230. A plurality of clamps 240 (240a, 240b and 240c) are attached to each supporting rail 220. A pair of clamps 240 are spaced apart on rails 220 to hold edge portions of the longer length (L) side of a photovoltaic module 100. Each clamp 240 has a back edge 250a that is closer to the beam 210 and a front edge 250b that overlaps the module 100 and extends over the edge delete area 20 and which is closer to the center of the photovoltaic module 100. As shown in FIG. 2, the clamps 240 extend over the modules 100 a certain distance beyond the edge delete area 20 of the module 100 thereby covering at least a portion of a plurality of photovoltaic cells 10.

In field operation, arrays 1000 can be subject to high voltage biasing at the clamp 240 areas under certain electrical connection and grounding conditions. At the clamp 240 areas, the front support 11 can have a positive electrical potential up to several hundred volts relative to the first conductive material 12 and other materials of the photovoltaic cell 10. It has been found that the high voltage biasing effect at the clamp 240 areas can significantly reduce the maximum power and efficiency of the module 100. Accordingly, there is a need for a mounting clamp and mounting clamp configuration for installing photovoltaic module arrays, which mitigates the reduction in power and efficiency of the module 100.

### BRIEF DESCRIPTION OF THE DRAWINGS

FIGS. 1A and 1B respectively show a top view and a side view of a photovoltaic module;

FIG. 2 is a schematic of a photovoltaic array installed on a photovoltaic module mounting assembly;

FIG. 3 is a schematic of a mounting clamp holding a portion of a photovoltaic module;

FIGS. 4A and 4B show voltage-current curves for a typical photovoltaic cell;

FIG. 5 shows a portion of a photovoltaic module after high voltage biasing at a mounting clamp area;

FIG. 6A is a top view of a photovoltaic module mounting assembly in accordance with a disclosed embodiment;

FIGS. 6B and 6C show a supporting element having a prefabricated clamp in accordance with a disclosed embodiment;

FIG. 7 depicts steps for installing a photovoltaic module on a photovoltaic module mounting assembly in accordance with a disclosed embodiment;

FIG. 8 is a top view of a photovoltaic module mounting assembly in accordance with a disclosed embodiment; and

FIG. 9 is a schematic of a mounting clamp holding a portion of a photovoltaic module in accordance with a disclosed embodiment.

### DETAILED DESCRIPTION OF THE INVENTION

In the following detailed description, reference is made to the accompanying drawings which form a part hereof, and in which is shown by way of illustration specific embodiments that may be practiced. It should be understood that like reference numbers represent like elements throughout the drawings. These embodiments are described in sufficient detail to enable those skilled in the art to make and use them, and it is to be understood that structural, material, electrical, and procedural changes may be made to the specific embodiments disclosed, only some of which are discussed in detail below.

Described herein are embodiments of a photovoltaic module mounting assembly having mounting clamps for connecting multiple photovoltaic modules to support rails. One embodiment of the mounting assembly includes mounting clamps arranged such that a plurality of clamps on the same side edge of a module are positioned on the mounting assembly parallel to the scribe lines of the module. Another embodiment of the mounting assembly uses mounting clamps that are configured to hold a portion of the module at a predetermined distance away from the photovoltaic cells of the module.

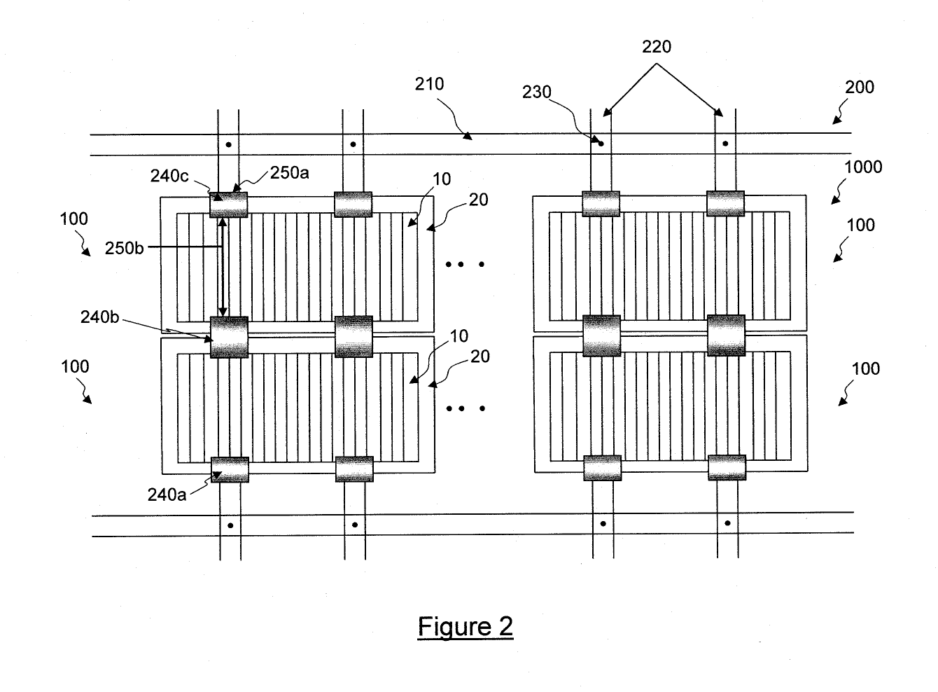

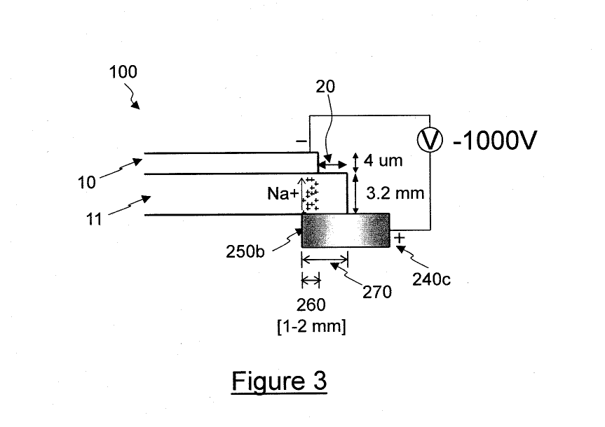

FIG. 3 shows in greater detail the top part of a mounting clamp 240 which holds an edge portion of the longer length (L) side of the photovoltaic module 100, in accordance with the conventional mounting assembly 200 shown in FIG. 2. The module 100 has a plurality of photovoltaic cells 10 formed on a front support 11. The clamp 240 has a length of about 250 mm and a width of about 25 mm. Looking at the module 100 from the top down, i.e., from the front support 11 to the cells 10, the clamp 240 extends a certain distance 270 over the front support 11 such as, for example, a distance 260 of 1 mm to 2 mm, beyond the edge delete area 20 on the longer length (L) side of the module 100, thereby overlying portions of a plurality of cells 10 of the module 100. By way of example, the front support 11 of the module 100 is about 3.2 mm thick and the photovoltaic cell is about 4 μm thick.

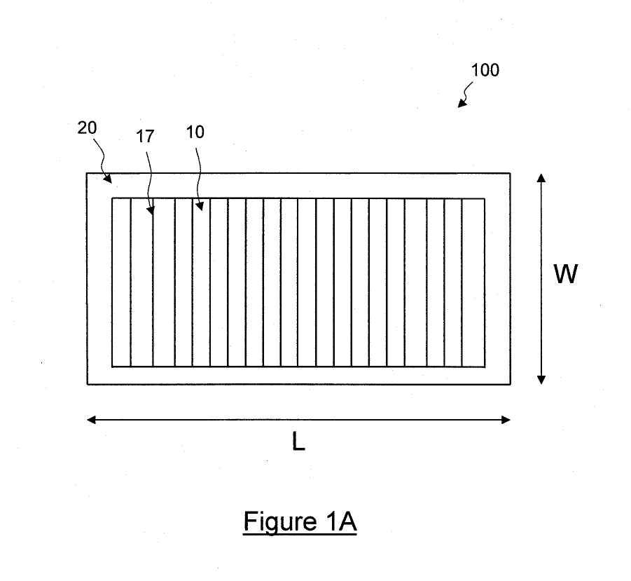

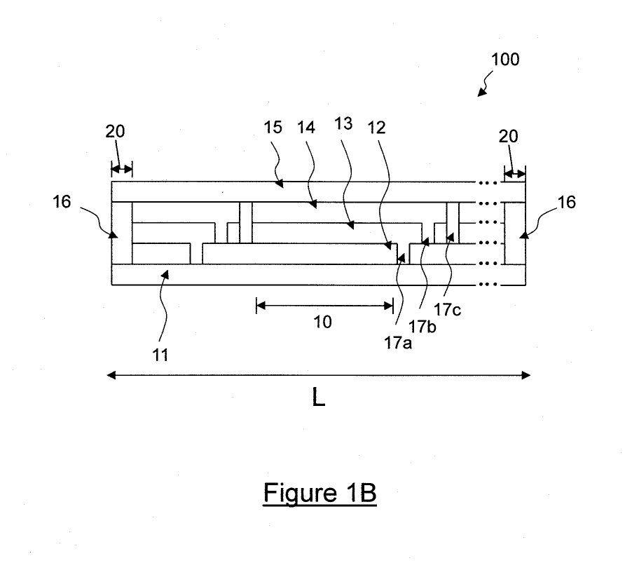

The front support 11 is typically made of soda lime glass, which is comprised of mostly silicon oxide (or silica), an alkali such as sodium bicarbonate (or soda) and lime Soda-lime glass has a substantial percentage of sodium ions, which can migrate across silicon oxide through Coulomb's law of attraction. That is, the force of attraction between two oppositely charged particles is directly proportional to the charges of the particles and inversely proportional to the square of the distance between them. Sodium ion (Na+) is the most mobile alkali charge carrier and can easily break away from the Coulomb bond and migrate through random diffusion or be driven to a cathode under an electric field. Assuming the photovoltaic module 100 can generate about 100 V, then ten series connected modules 100 in an array 1000 can generate 1000 V. In field operation, such arrays 1000 can be subject to high voltage biasing at the clamp 240 areas. At the clamp 240 areas, the front support 11 has a positive electrical potential up to several hundred volts relative to the first conductive material 12 (FIG. 1B) and other materials in the photovoltaic cell 10. The electric field generated at the front support 11 to the photovoltaic cells 10 can drive sodium ions (Na+) to migrate from the front support 11 to the cells 10, as shown in FIG. 3. Because the cell 10 is only about 4 μm thick, mobile ions can easily migrate vertically through the cell 10.

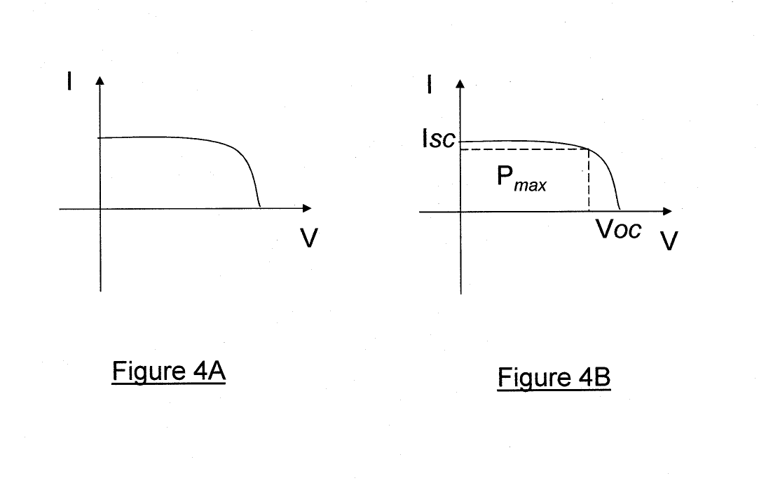

The migration of mobile ions can cause leakage of current through the photovoltaic cells 10 and around the edges 20 of the cells 10 leading to module performance degradation on voltage-current characteristics (i.e., IV curve). Typical voltage-current characteristics of a photovoltaic cell can be approximated using the exemplary IV curve shown in FIG. 4A. The power delivered to a load is zero at the open circuit voltage (Voc) and the short circuit current (Isc) and reaches a maximum (Pₘₐₓ) at a finite load resistance value as shown in FIG. 4B. The efficiency of a cell is defined as:

$${η}_{max} = \frac{{P}_{max}}{{P}_{in}}$$

which is the ratio of the electrical power delivered to the load (Pₘₐₓ) to the power incident on the cell (Pᵢₙ). The maximum efficiency is when power delivered to the load is Pₘₐₓ.

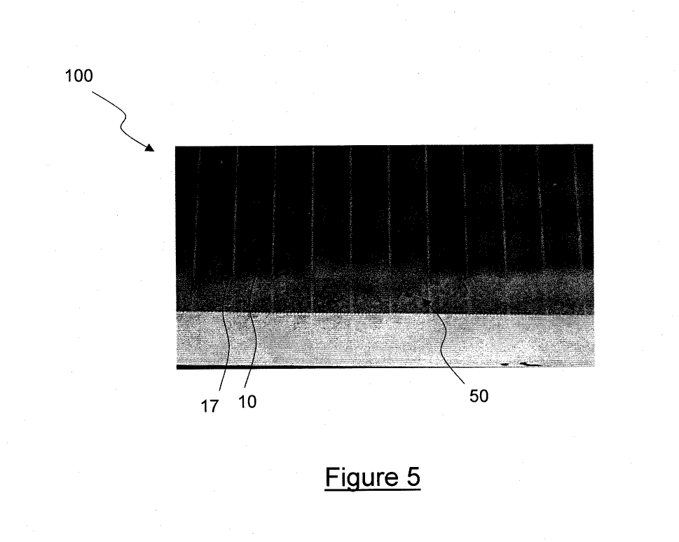

Photovoltaic module performance degradations at and near the clamp 240 areas can be measured using an accelerated damp heat with voltage bias test called the Damp Heat With Bias (DHWB) test. This test is used to primarily assess the resistance of modules to the electric field generated from the front support 11 to the photovoltaic cells 10 (FIG. 1B) that can drive sodium to migrate and cause module performance degradations. The DHWB test is run in an environmental chamber typically set for an ambient temperature of 85° Celsius and a relative humidity of 85%. A −1000V biasing voltage (FIG. 3) is applied to the front support 11 at the clamps 240 areas to simulate the biasing. During the testing period, it is estimated that sodium ions equivalent of more than 2000 milli-Coulomb/cm² can be driven from the front support 11 to the photovoltaic cells 10. Laboratory DHWB testing of the module 100 under the above-described conditions for approximately 330 hours at the clamp 240 areas indicate performance degradations of up to a 20% drop in maximum power and about 15-30% drop in efficiency. The migration of mobile ions can also cause visual defects 50 to be formed on the module 100 at and near the clamp 240 areas, as shown in FIG. 5.

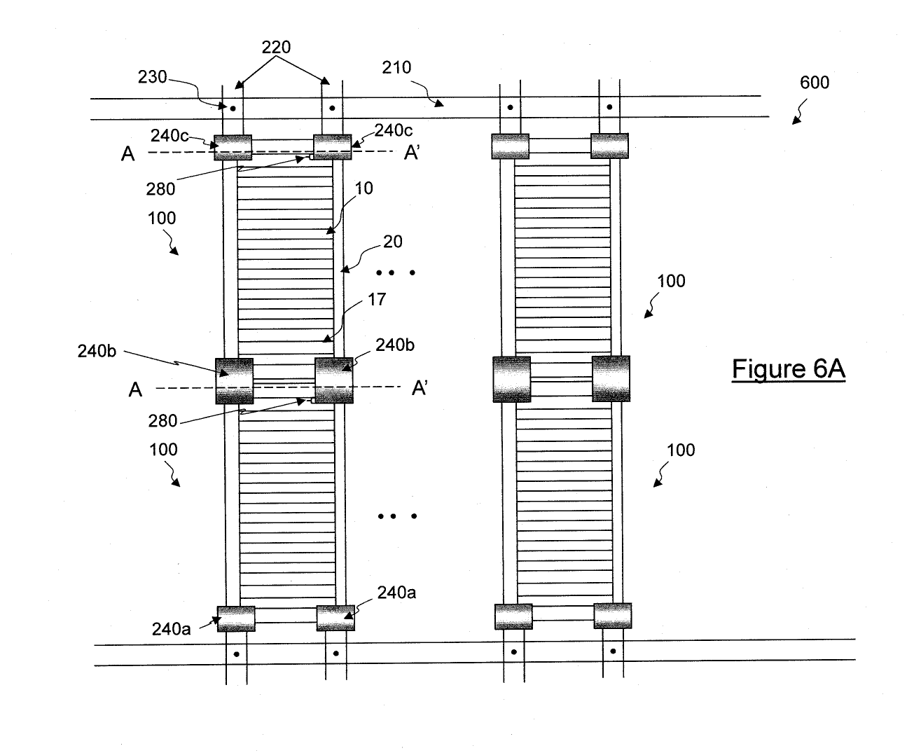

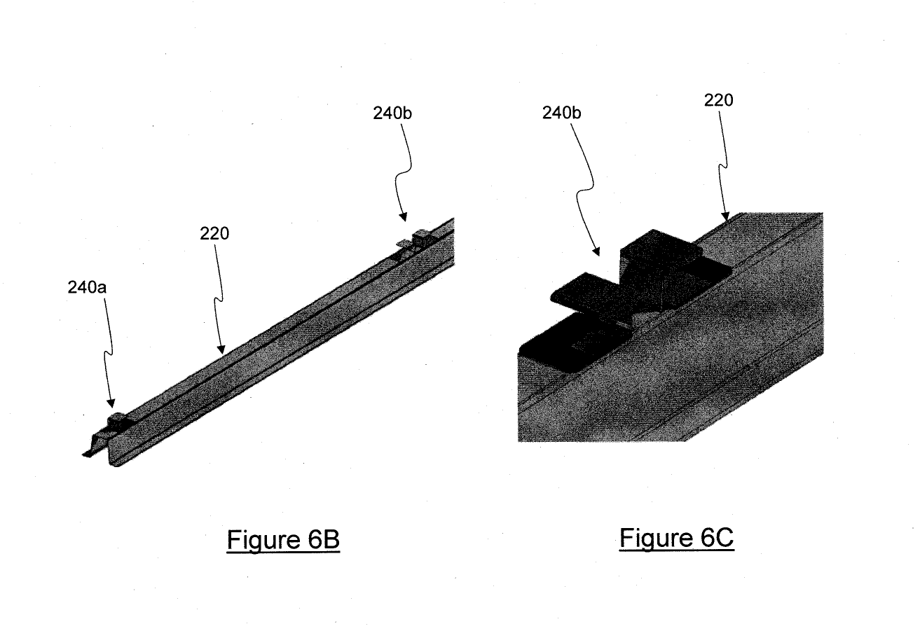

FIG. 6A is a top view of a photovoltaic module mounting assembly 600 having mounting clamps 240 (240a, 240b and 240c) in accordance with an embodiment of the invention. The mounting assembly 600 includes a plurality of supporting beams 210 and a plurality of supporting rails 220. The supporting beams 210 are substantially parallel to each other. The supporting rails 220 are substantially parallel to each other and are fastened substantially perpendicular to the supporting beams 210 using connectors 230, such as a rivet or any other suitable fastener. A plurality of clamps 240 are attached to each supporting rail 220. In this embodiment, the module 100 is rotated 90 degrees from the orientation of the module 100 in FIG. 2 such that the mounting clamps 240 hold edge portions of the shorter width (W) side of the module 100. Each pair of mounting clamps 240 on a side of a module 100 is positioned on the mounting assembly 600 parallel to the scribe lines 17 of the module 100 as shown by the lines A-A′ in FIG. 6A. The beams 210, rails 220 and clamps 240 can be made of a metal material, such as, aluminum or steel. Although FIG. 6A shows two pairs of clamps 240 holding the shorter edge of module 100, it shall be appreciated that any number of clamps may be used.

When looking at the module 100 from the top down in FIG. 6A, the clamps 240 extend a certain distance over the module 100 edge beyond the edge delete area 20 such as, for example, a distance 280 of 1 mm to 2 mm, beyond the edge delete area 20 on the longer length (L) side of the module 100. Unlike the mounting assembly 200 shown in FIG. 2, the mounting clamps 240 cover a portion of at most one photovoltaic cell 10 when the clamps 240 are positioned along line A-A′ in parallel to the scribe lines 17 of the module 100. The mounting clamps 240 can hold a corner portion of the photovoltaic module 100 as shown in FIG. 6A or any edge portion of the shorter width (W) side of the module 100. Although the mounting assembly 600 is shown in FIG. 6A holding four photovoltaic modules 100, it should be appreciated that the assembly 600 may hold any number of photovoltaic modules 100 in any row and column configuration.

Laboratory DHWB testing of the biasing induced effects of the mounting clamps 240 placed at the shorter width (W) side of the module 100 showed significantly less performance degradation on the module 100 compared to placing the clamps 240 at the longer length (L) side of the module 100. For example, there is about a 2% drop in efficiency when the clamps 240 hold only edge portions of the shorter width (W) side of the module 100 compared to about a 15% to 30% drop in efficiency when the clamps 240 hold edge portions of the longer length (L) side of the module 100.

It shall be appreciated that the clamps 240 may be mounted on the rail 220 after the module 100 are placed thereon or the rails 220 may be prefabricated with clamps 240 into which the modules 100 may slide in the manner described in application Ser. No. 12/846,365, the entirety of which is incorporated herein by reference. FIG. 6B shows a partial portion of a rail 220 having a prefabricated clamp 240a and a prefabricated clamp 240b. FIG. 6C shows a detailed view of a portion of the rail 220 with a prefabricated clamp 240b. Clamps 240a and 240c hold the edge portion of one photovoltaic module 100 while clamps 240b hold the edge portions of two photovoltaic modules 100 as shown in FIG. 6A. Other types of mounting clamps 240 can be mounted or prefabricated on the rails 220.

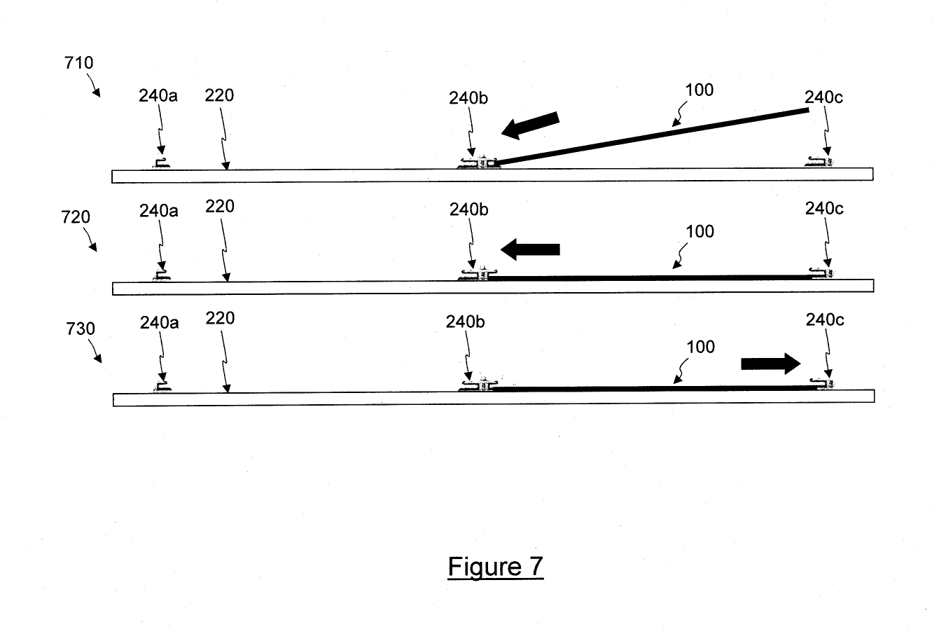

FIG. 7 depicts steps for installing the photovoltaic module 100 on the photovoltaic module mounting assembly 600 using mounting clamps 240b and 240c. At step 710, a first edge portion of the photovoltaic module 100 is inserted into the mounting clamp 240b such that scribe lines of the module 100 are oriented parallel to the mounting clamp 240b as described above. Next, at step 720, the module 100 is laid down parallel to the rail 220. Then at step 730, a second edge portion opposite to the first edge portion of the photovoltaic module 100 is inserted into the mounting clamp 240c. It shall be appreciated that the placement location of the module clamps 240 on the mounting assembly 600 can be easily modified to accommodate photovoltaic modules 100 of any width and length.

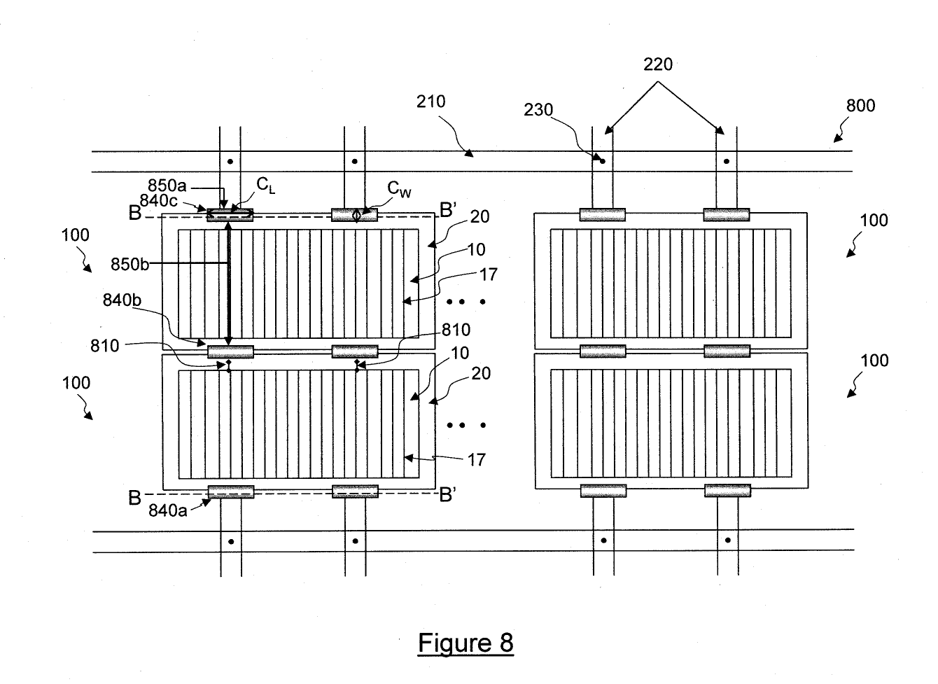

FIG. 8 is a top view of an embodiment of a photovoltaic module mounting assembly 800 using mounting clamps 840 (840a, 840b and 840c). Mounting clamps 840 are configured to hold an edge portion of the longer length (L) side of the module 100. The top portion of clamp 840 has a back edge 850a that is closer to the beam 210 and a front edge 850b that is closer to the center of the photovoltaic module 100. The front edge 850b of clamp 840 which overlaps module 100 is positioned at a predetermined distance 810 away from the edge of cell 10 of the module 100. Similar to the mounting assembly 200 shown in FIG. 2, the clamps 840 hold edge portions of the longer length (L) side of the module 100 such that the clamps 840 are positioned on the mounting assembly 800 perpendicular to the scribe lines 17 of the module 100 as shown by cross section B-B1 in FIG. 8. Unlike the mounting assemblies shown in FIGS. 2 and 6A, the shape and dimension of the clamp 840 is modified in order to reduce the damaging effects caused by high voltage biasing at the clamp 840 area. The differences between clamp 840 and clamp 240 are explained below. Clamp 840 is narrower in width (C_{W}) than clamp 240. The clamp 840 has a width (C_{W}) less than 25 millimeters, preferably less than 10 millimeters. The overlapping front edge 850b of clamp 840 is laterally positioned a distance 810 which is at least 1 mm away from the edge of cell 10 of the module 100. For example, the distance 810 between the front edge 850b of the clamp 840 and the edge of cell 10 may be about 2 millimeters. Clamp 840 may also be shorter in length (C_{L}) than clamp 240. As one example, the clamp 840 may have a width (C_{W}) of about 6 mm and a length (C_{L}) of about 150 mm. Although FIG. 8 shows two pairs of clamps 840 holding sides of the module 100, it shall be appreciated that any number of clamps may be used.

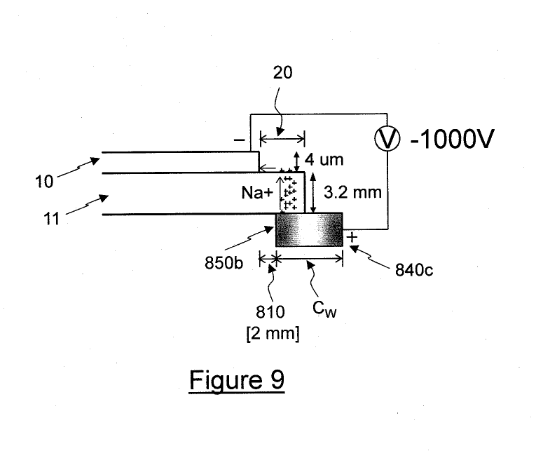

FIG. 9 systematically shows a top portion of clamp 840c holding an edge portion of the longer length (L) side of the photovoltaic module 100 in accordance with FIG. 8. In contrast to FIG. 3, clamp 840c has a width (C_{W}) sufficiently narrow such that the front edge 850b of clamp 840c is a predetermined distance 810 of least 1 mm away from the edge of cell 10 of the module 100. The front edges 850b of the clamps 840 shown in FIGS. 8 and 9 are each laterally positioned 2 mm away from the edge of cell 10. By positioning the clamps 840 a predetermined distance 810 away from the edge of cell 10, the sodium ions and other mobile ions must migrate an additional minimum distance 810 laterally along the front support 11 to reach a photovoltaic cell 10. Electroluminescence imaging and optical micrographs of the mounting clamp 840 areas in the mounting assembly 800 showed almost no damage (e.g., visual defects or shunting) on the module 100. In addition, laboratory DHWB testing of the biasing induced effects of using the mounting clamps 840 showed significantly less performance degradation on the module 1.00 compared to using the clamps 240 that covered portions of multiple cells 10. For example, the use of mounting clamps 840 in the manner described above with respect to FIG. 8 resulted in only about a 3% drop in maximum efficiency and about a 2% drop in maximum power. By contrast, the use of mounting clamps 240 resulted in about a 15% to 30% drop in maximum efficiency and power. It shall be appreciated that the placement location of the module clamps 840 on the mounting assembly 800 can be easily modified to accommodate photovoltaic modules 100 of any width and length.

It shall be appreciated that the placement of the clamps 240 in embodiment of FIG. 6A may be combined with the configuration of the clamps 840 in embodiment of FIG. 8 to further minimize the effects of the biasing on module performance. The embodiments described above are offered by way of illustration and example. It should be understood that the examples provided above may be altered in certain respects and still remain within the scope of the claims. It should be appreciated that, while the invention has been described with reference to the above example embodiments, other embodiments are within the scope of the claims.

What is claimed as new and desired to be protected by Letters Patent of the United States is:

1. An apparatus for holding an edge portion of a photovoltaic module, comprising:
a support element; and
a mounting clamp attached to the support element, the mounting clamp being positioned parallel to scribe lines of the photovoltaic module when holding the edge portion of the photovoltaic module such that at most a single photovoltaic cell of the photovoltaic module is covered by the mounting clamp.

2. The apparatus of claim 1, wherein the mounting clamp extends beyond an edge delete area of the photovoltaic module.

3. The apparatus of claim 1, wherein a front edge of the mounting clamp is laterally positioned at least 1 millimeter away from a photovoltaic cell of the photovoltaic module when viewing the module top down such that no photovoltaic cell is covered by the mounting clamp.

4. The apparatus of claim 3, wherein the mounting clamp is positioned perpendicular to scribe lines of the photovoltaic module when holding the edge portion of the photovoltaic module.

5. The apparatus of claim 3, wherein the front edge of the mounting clamp is laterally positioned about 2 millimeters away from any photovoltaic cell of the photovoltaic module.

6. The apparatus of claim 3, wherein the mounting clamp has a width of less than 25 millimeters.

7. The apparatus of claim 6, wherein the mounting clamp has a width of approximately 6 millimeters.

8. The apparatus of claim 3, wherein the mounting clamp has a length of approximately 150 millimeters.

9. The apparatus of claim 1, wherein the mounting clamp has a width of less than 10 millimeters.

10. The apparatus of claim 1, wherein the mounting clamp holds edge portions of two adjacent photovoltaic modules.

11. The apparatus of claim 1, further comprising:
a plurality of rails spaced apart; and
at least one pair of mounting clamps for holding edge portions of a photovoltaic module, the pair of mounting clamps being positioned parallel to scribe lines of the photovoltaic module when holding the edge portions of the photovoltaic module such that at most a single photovoltaic cell of the photovoltaic module is covered by the pair of mounting clamps.

12. The photovoltaic module mounting assembly of claim 11, wherein each mounting clamp holds a corner edge portion of the photovoltaic module.

13. The photovoltaic module mounting assembly of claim 11, wherein the photovoltaic module is installed on the photovoltaic module mounting assembly such that a front edge of a respective mounting clamp is laterally positioned at least 1 millimeter away from a photovoltaic cell of the photovoltaic module when viewing the module top down.

14. A photovoltaic module mounting assembly, comprising:
a plurality of rails spaced apart; and
at least one pair of mounting clamps for holding edge portions of a photovoltaic module, a top portion of each mounting clamp is located above an edge delete area of the photovoltaic module and has a front edge that is laterally positioned at least 1 millimeter away from a photovoltaic cell of the photovoltaic module.

15. The photovoltaic module mounting assembly of claim 14, wherein each mounting clamp of the pair is positioned parallel to scribe lines of the photovoltaic module when holding the edge portion of the photovoltaic module such that at most a single photovoltaic cell of the photovoltaic module is covered by the pair of mounting clamps.

16. The photovoltaic module mounting assembly of claim 14, wherein the front edge of each mounting clamp of the pair is laterally positioned about 2 millimeters away from any photovoltaic cell of the photovoltaic module.

17. The photovoltaic module mounting assembly of claim 14 wherein each mounting clamp of the pair has a width of less than 10 millimeters.

18. The photovoltaic module mounting assembly of claim 14, wherein each mounting clamp of the pair holds a corner edge portion of the photovoltaic module.

19. A method of installing a photovoltaic module on a support element having preassembled mounting clamps, the method comprising:
inserting a first edge portion of the photovoltaic module into a first mounting clamp such that scribe lines of the photovoltaic module are positioned parallel to the first mounting clamp and at most a single photovoltaic cell of the photovoltaic module is covered by the first mounting clamp when holding the first edge portion;
laying the photovoltaic module parallel to the support element; and
inserting a second edge portion opposite to the first edge portion of the photovoltaic module into a second mounting clamp on the support element opposite to the first mounting clamp.
